(19) United States
(12) Patent Application Publication
(10) Pub. No.: US 2007/0026259 A1
(43) Pub. Date: Feb. 1, 2007

(54) Thermal recording material

(76) Inventor: Satoshi Kano, Chiyoda-ku (JP)

Correspondence Address: NIXON & VANDERHYE, PC, 901 NORTH GLEBE ROAD, 11TH FLOOR, ARLINGTON, VA, 22203, US

(21) Appl. No.: 10/555,082

(22) PCT Filed: Sep. 3, 2004
(86) PCT No.: PCT/JP04/13194

§ 371 Date: May 12, 2006

(30) Foreign Application Priority Data
Oct. 14, 2003 (JP) 2003-353144

(51) Int. Cl. G11B 5/33

(52) U.S. Cl. 428/800

(57) ABSTRACT

The present invention provides a thermal recording material excellent in water resistance and oil resistance and satisfactory in wriatbility and stampability. The thermal recording material of the present invention includes a thermally colorable thermal recording layer formed on a substrate and a protective layer formed on said thermal recording layer, in which said protective layer contains a polyvinyl alcohol, chitosan, a crosslinking agent and a pigment, and said pigment contains colloidal silica. Preferably, at least one member selected from an aldehyde-containing compound, a polyamide epichlorohydrin resin or an isocyanate compound is used as said crosslinking agent, and particularly, at least two members selected from an aldehyde-containing compound, a polyamide epichlorohydrin resin and an isocyanate compound are used.

### TECHNICAL FIELD

The present invention relates to a thermal recording material comprising a thermally colorable thermal-recording layer and a protective layer which are consecutively formed on a substrate, and particularly to a thermal recording material excellent in water resistance and oil resistance and satisfactory in writability and stampability.

### TECHNICAL BACKGROUND

Thermal recording materials are available at low prices, recording devices for use therewith are simple, printers for use therewith can be downsized, and their maintenance is easy, so that in recent years they have rapidly come to be widely used in the fields of facsimile paper, ATM/CD receipts, receipts for charges for gas, water, electricity, etc., issued with handy terminals, passenger tickets, coupons, receipts, labels, and the like. While thermal recording materials are so diversified with regard to fields of use and demands, they are now required to have various properties such as image retainability, high-sensitivity stampability, the running property for recording, and the like. Particularly, when a thermal recording material is. used with a terminal machine that is used outdoors. such as a handy terminal, or the like, or in the fields of food labels, etc., the image retainability against contacts to water or chemicals contained in cosmetics, stationery products, food wrapping materials, etc., is the most important problem to be addressed.

For improving the above thermal recording material in image retainability, there has been proposed a method in which a protective layer having water resistance and oil resistance for preventing the infiltration of water, oils, plasticizers, etc., is formed on a thermal recording layer. In the present specification, the “oil resistance” refers to resistance of a thermal recording material against a decrease in recording density and a ground fogging that are caused by the contact of the thermal recording material to oils such as a solvent, plasticizers contained in wrapping materials, human sebum, and the like.

For improving thermal recording materials in abrasion-fogging resistance, retainability, the property of matching to a thermal-recording head, etc., for example, there are proposed a method in which a film of a film-formable polymer is formed on a thermal recording layer surface (for example, see JP-A-48-051644), a method in which an acid-resistant and solvent-resistant protective film is formed on a thermal recording layer surface (for example, see JP-A-54-128347), a method in which a protective film obtained from a carboxyl-group-modified polyvinyl alcohol is formed on a thermal recording layer surface (for example, see JP-A-56-126193), a method in which a protective film obtained from a combination of a carboxyl-group-modified polyvinyl alcohol with a polyamide epoxy resin is formed on a thermal recording layer surface (for example, see JP-A-59-162088), and a method in which a coating liquid containing an emulsion of composite particles of colloid-formable inorganic silicate and colloidal silica is applied onto a thermal recording layer and the applied liquid is dried (for example, see JP-A-2-274589).

In recent years, however, recording devices are further decreased in size and enhanced in electric power saving, so that thermal recording materials obtained by the above methods can no longer satisfy the image retainability against water and chemicals (water resistance and oil resistance) while maintaining the printing sensitivity and the running property for recording.

With regard to a thermal recording material comprising a thermally colorable thermal recording layer formed on a substrate and a protective layer formed on said thermal recording layer, it is proposed that when a polyvinyl alcohol resin, chitosan and an aldehyde compound are used in the above thermal recording layer or the above protective layer, there are produced excellent barrier properties (for example, see JP-A-61-162383). The above thermal recording material has a problem that it is impaired in gloss, clearness of a printing, water resistance and oil resistance when a pigment is used for improving the material in suitability to a thermal head, writability and stampability. Further, there is also proposed a thermal recording material of which the protective layer contains chitosan for improving the thermal recording material in water resistance, oil resistance and matching to a head (for example, see JP-A-5-572 and JP-A-9-175022). However, the above thermal recording material is insufficient for attaining both satisfaction of water resistance and oil resistance and satisfaction of writability and stampability.

Disclosure of the Invention

It is an object of the present invention to provide a thermal recording material that overcomes the above defects and that is excellent in water resistance and oil resistance and is satisfactory in writability and stampability.

The thermal recording material of the present invention is a thermal recording material comprising a thermally colorable thermal recording layer formed on a substrate and a protective layer formed on said thermal recording layer,

(1) in which said protective layer contains a polyvinyl alcohol, chitosan, a crosslinking agent and a pigment, and said pigment contains colloidal silica.

Further, it is (2) a thermal recording material as recited in (1), wherein as said crosslinking agent is used at least one member selected from an aldehyde-containing compound, a polyamide epichlorohydrin resin and an isocyanate compound.

Further, it is (3) a thermal recording material as recited in (2), wherein as said crosslinking agent are used at least two members selected from an aldehyde-containing compound, a polyamide epichlorohydrin resin and an isocyanate compound.

Further, it is (4) a thermal recording material as recited in (1), wherein said colloidal silica is cationic colloidal silica.

Further, it is (5) a thermal recording material as recited in (1), wherein said polyvinyl alcohol and said chitosan have a solid content mass ratio of from 7:3 to 9:1.

Further, it is (6) a thermal recording material as recited in (1), wherein said polyvinyl alcohol is at-least one member selected from a non-modified polyvinyl alcohol having a saponification degree of at least 95%, a silanol-modified polyvinyl alcohol, an epoxy-modified polyvinyl alcohol, a diacetone-modified polyvinyl alcohol or an acetoacetyl-modified polyvinyl alcohol.

Further, preferably, it is (7) a thermal recording material as recited in (1), wherein said protective layer contains a water-dispersible binder other than any anionic binder.

In the thermal recording material of the present invention, the protective layer comprises a polyvinyl alcohol, chitosan, a crosslinking agent and a pigment, and the pigment contains a colloidal silica, so that the thermal recording material is excellent in water resistance, oil resisance, writability and stampability. Particularly, when an aldehyde compound is used as a crosslinking agent, there can be obtained a thermal recording material excellent in water resistance; when a polyamide epichlorohydrin resin is used as a crosslinking agent, there can be obtained a thermal recording material excellent in prinability and whiteness; and when an isocyanate compound is used as a crosslinking agent, there can be obtained a thermal recording material excellent in whiteness. Further, when the polyvinyl alcohol used is at least one member selected from a non-modified polyvinyl alcohol having a saponification degree of at least 95%, a silanol-modified polyvinyl alcohol, an epoxy-modified polyvinyl alcohol, a diacetone-modified polyvinyl alcohol or an acetoacetyl-modified polyvinyl alcohol, there can be obtained a thermal recording material excellent in water resistance. Further, when a water-dispersible binder other than any anionic binder is added, there can be obtained a thermal recording material excellent in water resistance and stampability, and when the colloidal silica is increased in average particle diameter, there can be obtained a thermal recording material excellent in stampability and writability with a pencil.

Best Embodiments for Practicing the Invention

The thermal recording material of the present invention will be explained in detail hereinafter.

The thermal recording material of the present invention is a thermal recording material comprising a thermally colorable thermal recording layer formed on a substrate and a protective layer formed on said thermal recording layer, in which said protective layer contains a polyvinyl alcohol, chitosan, a crosslinking agent and a pigment, and said pigment contains colloidal silica.

First, the protective layer will be explained.

In the present invention, the polyvinyl alcohol that is incorporated into the protective layer includes a non-modified polyvinyl alcohol, and in addition thereto, the polyvinyl alcohol includes a carboxyl-group-modified polyvinyl alcohol, a sulfonic-acid-group-modified polyvinyl alcohol, a phosphoric-acid-group-modified polyvinyl alcohol, a silanol-modified polyvinyl alcohol, an epoxy-modified polyvinyl alcohol, a diacetone-modified polyvinyl alcohol and an acetoacetyl-modified polyvinyl alcohol, and also includes a modified polyvinyl alcohol obtained by copolymerization with ethylene, a vinyl ether having a long-chain alkyl group, (meth)acrylamide, or the like.

When it is required to further improve the thermal recording material in water resistance, it is suitable to select at least one member from a non-modified polyvinyl alcohol having a saponification degree of at least 95%, a silanol-modified polyvinyl alcohol, an epoxy-modified polyvinyl alcohol, a diacetone-modified polyvinyl alcohol and an acetoacetyl-modified polyvinyl alcohol among the above polyvinyl alcohols.

The above polyvinyl alcohol works as a binder in the protective layer.

Although being not critical, the polymerization degree of the polyvinyl alcohol is generally selected from the range of 100 to 3,000. Further, while the saponification degree is not critical so long as the polyvinyl alcohol is soluble in water, it is generally selected from the range of 70 to 100 mol %.

In the present invention, chitosan is that which is obtained by deacetylation of chitin, and it is preferably a product obtained by modification of at least 50% of acetylamino groups of chitin into amino groups by deacetylation, and more preferably a product obtained by modification of at least 90% of them into amino groups by deacetylation. When the chitosan is used, some or all of the amino groups are converted to ammonium groups with an acid before use. The acid is generally selected from acetic acid, lactic acid, triphosphoric acid, citric acid, sulfamic acid, hydrochloric acid, sulfuric acid, formic acid, fumaric acid or maleic acid.

Like polyvinyl alcohol, the above chitosan works as a binder in the protective layer.

While the molecular weight of the chitosan is not critical, preferably, the chitosan has a low molecular weight corresponding to a viscosity of 1 to 70 centipoises when an aqueous solution containing 1% by mass thereof is measured with a BL type viscometer at 20° C., when the compatibility thereof with polyvinyl alcohol, etc. is considered. Further, the above chitosan having a low molecular weight has a problem that it comes to be colored in yellow or brown with the passage of time. In such a case, there may be used a stabilized chitosan which is found in JP-A-63-72702, or the like.

The content of the polyvinyl alcohol and chitosan in the protective layer is preferably 15 to 80 mass % based on the total solid content of the protective layer. It is particularly preferably 30 to 80 mass % in view of oil resistance, and it is particularly preferably 15 to 60 mass % in view of writability and stampability.

Further, the solid content mass ratio of the polyvinyl alcohol and chitosan is preferably from 5:5 to 9.7:0.3, more preferably from 7:3 to 9:1. When the content of the chitosan is too small, the thermal recording material is degraded in water resistance. When it is too large, there is likely to be caused a problem that a coating. liquid for the protective layer is increased in viscosity or that the thermal recording material obtained comes to be colored with the passage of time.

In the present invention, the protective layer may contain other binder in addition to the polyvinyl alcohol and chitosan, and a water-dispersible binder can be employed as such a binder. The addition of a water-dispersible binder improves the affinity of the thermal recording material with an oil ink, so that the thermal recording material can be improved in suitability to printing and stampability. In the present invention, the water-dispersible binder refers to a binder obtained by emulsification of a resin with a dispersant, etc. or a binder composed of a self-emulsifiable resin. The water-dispersible binder generally includes a styrene/butadiene copolymer, an acrylonitrile/butadiene copolymer, a methyl acrylate/butadiene copolymer, an acrylonitrile/butadiene/styrene terpolymer, polyvinyl acetate, a vinyl acetate/acrylic ester copolymer, an ethylene/vinyl acetate copolymer, a polyacrylic ester copolymer, a styrene/acrylic ester copolymer and polyurethane. In view of stampability, acrylic-ester-based resin is particularly preferred. Further, a water-dispersible binder that is obtained by using an anioic surfactant when produced and an anioic water-dispersible binder obtained by partial neutralization of a resin having an acidic group are not preferred in view of liquid properties since chitosan is cationic. For this reason, the water-dispersible binder is.preferably a non-anionic water-dispersible binder.

The amount of the water-dispersible binder is preferably at least 5 mass % but not more than 60 mass % based on the total binder content of the protective layer. When it is in the above range, there can be obtained particularly preferable oil resistance and affinity with an oil ink.

In the present invention, the crosslinking agent to be contained in the protective layer includes an aldehyde-containing compound, a polyamide epichlorohdyrin resin, an isocyanate compound (including a block isocyanate compound, etc.), boric acid, borax, a urea resin, a melamine resin, methylol compounds such as a phenolic resin, etc., epoxy compounds such as a polyfunctional epoxy resin, etc., and oxidants such as persulfate, peroxide, etc., and it is preferred to use at least one member selected from an aldehyde-containing compound, a polyamide epichlorohydrin resin or an isocyanate compound.

Of the above crosslinking agents, an adehyde-containing compound is particularly preferred for improving the thermal recording material in water resistance. The aldehyde-containing compound includes formalin, glyoxal, etc, and any compound can be used without any special limitation so long as it generates an aldehyde in a protective layer coating liquid.

When used as a crosslinking agent, a polyamide epichlorohydrin resin can improve the thermal recording material in stampability. Further, it can be also improve the thermal recording material in durability against yellowing caused by yellow-coloring of chitosan (to be sometimes referred to as “yellowing durability” hereinafter).

The polyamide epichlorohydrin resin can be obtained by reacting a polyamide resin obtained by condensation of a dicarboxylic acid compound and a polyalkylene polyamine compound, with epichlorohydrin, for example, according to a method described in the section of Prior Art in JP-A-9-31192.

The dicarboxylic acid compound includes adipic acid, itaconic acid, malonic acid, succinic acid, sebacic acid, glutaric acid, etc., and the polyalkylene polyamine compound includes diethyltriamine, triethylenetetramine, and the like.

The polyamide epichlorohydrin resin obtained by reacting a polyamide resin obtained from adipic acid as a dicarboxylic acid compound and diethylenetriamine as a polyalkylene polyamine compound, with epichlorohydrin is a polymer having a recurring unit represented by the general formula (I).

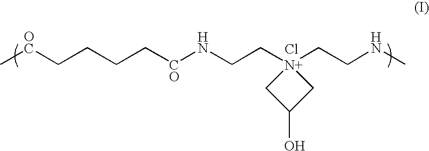

When an isocyanate compound is used as a crosslinking agent, the yellowing durability can be improved.

The isocyanate compound is not specially limited so long as it is a compound having an isocyanate group or a blocked isocyanate group, and an isocyanate compound having 2 or more isocyanate groups is preferred. Examples of the isocyanate compound include aliphatic isocyanates such as hexamethylene diisocyanate, aromatic isocyanates such as m-phenylene diisocyanate, p-phenylene diisocyanate, tolyene-2,4-diisocyanate, tolyene-2,6-diisocyanate, diphenylmethane-4,4′-diisocyanate, diphenylene-4,4′-diisocyanate, 4,4′-diisocyanate-3,3′-dimethyldiphenyl, 3-methyl-diphenylmethane-4,4′-diisocyanate and diphenyl ether diisocyanate, and alicyclic isocyanates such as cyclohexane-2,4-diisocyanate, cyciohexane-2,3-diisocyanate and isophorone diisocyanate.

The blocked isocyanate compound included in the isocyanate compound is a compound blocked with a blocking agent such as a phenol-, alcohol-, active methylene-, mercaptane-, amide-, imide- or sulfite-containing blocking agent. For achieving both a pot life and high water resistance, there may be used an isocyanate compound emulsion prepared according to a method found in JP-A-49-96077, or there may be used a commercially available isocyanate (for example, Aquanate series supplied by Nippon Polyurethane Industry Co., Ltd., DURANATE WB series supplied by Asahi Chemicals Corporation, DNW-5000 series supplied by Dainippon Ink and Chemicals Inc., or the like).

Further, as the above crosslinking agent, it is preferred to use at least two members selected from an aldehyde-containing compound, a polyamide epichlorohydrin resin and an isocyanate compound.

When the aldehyde-containing compound and the polyamide epichlorohydrin resin are used, there can be obtained a thermal recording material that achieves both water resistance and stampability. Further, when the aldehyde-containing compound and the isocyanate compound are used, there can be obtained a thermal recording material that achieves both water resistance and yellowing durability. Further, when the polyamide epichlorohydrin resin and the isocyanate compound are used, there can be obtained a thermal recording material that achieves both stampability and yellowing durability. Furthermore, when the aldehyde-containing compound, the polyamide epichlorohydrin resin and the isocyanate compound are used, there can be obtained a thermal recording material that is well-balanced among water resistance, stampability and yellowing durability.

In the present invention, preferably, the amount of the crosslinking agent to be incorporated into the protective layer is in the range of 0.1 to 20 mass % based on the sum total of solid content mass of the polyvinyl alcohol and chitosan. When it is in the above range, there can be obtained a protective layer that is stable in water resistance, oil resistance, printing sensitivity and the running property for recording.

The pigment contained in the protective layer contains colloidal silica, and as such colloidal silica, it is preferred to use colloidal silica having an average particle diameter in the range of 3 to 200 nm, since it has low precipitability in the protective layer coating liquid. With an increase in the particle diameter of the colloidal silica, the thermal recording material is more improved in the running property for recording with a thermal recording head, writability and stampability. When high transparency is required, however, the above particle diameter is preferably in the range of 3 to 50 nm. When the colloidal silica is used, the thermal recording material is more improved in the running property for recording with a thermal recording head, writability and stampability without impairing gloss and barrier properties. Generally, the content of the colloidal silica based on the total solid content of the protective layer is preferably 5 mass % to 85 mass %, more preferably 10 mass % to 70 mass %.

Of colloidal silica types, further, cationic colloidal silica is well compatible with chitosan and does not easily cause gelling or coagulation of a protective layer coating liquid. The cationic colloidal silica refers to colloidal silica in which at least silica particle surfaces are cationically charged since a compound of polyvalent metal ion such as aluminum ion or the like or an organic cationic compound is contained on silica surfaces or inside each particle. Of cationic colloidal silica types, colloidal silica cationized with basic aluminum is particularly preferred.

In the present invention, as a pigment, a conventionally known pigment may be used in a small amount in addition to the colloidal silica. The pigment can be selected from inorganic pigments such as diatomite, talc, kaolin, calcined kaolin, calcium bicarbonate, precipitable calcium carbonate, chalk, magnesium carbonate, zinc oxide, aluminum oxide, aluminum hydroxide, magnesium hydroxide, titanium dioxide, barium sulfate, zinc sulfate, amorphous silica, amorphous calcium silicate, etc., and organic pigments such as a melamine resin filler, a urea-formalin resin filler, a polyethylene powder, a nylon powder, and the like. Of these, aluminum hydroxide is effective for improving a thermal recording head in prevention of abrasion, and amorphous silica is effective for the thermal recording material in prevention of sticking to a thermal recording head.

For improving the running properties such as prevention of the abrasion of a thermal recording head, prevention of sticking to a thermal recording head, and the like, the protective layer contains, as required, higher fatty acid metal salts such as zinc stearate and the like, higher fatty acid amides such as stearamide and the like, and waxes such as paraffin, polyethylene wax, polyethylene oxide, castor wax and the like.

In the present invention, the solid content coating amount of the protective layer is preferably 0.3 to 10 g/m². When it is in the above range, there can be obtained a protective layer excellent in water resistance, oil resistance and printing sensitivity. As a layer constitution, the protective layer may be a single layer or a multi-layer so long as the coating amount is in the above range.

The thermal recording layer will be explained below.

In the present invention, materials to be contained in the thermal recording material are not specially limited, and any materials can be used so long as a combination thereof causes a coloring reaction by means of energy applied by a thermal recording head. For example, the above combination includes a combination of a colorless or light-colored electron-donating dye precursor with an electron-accepting developer and a combination of an aromatic isocyanate compound with an imino compound.

While the colorless or light-colored electron-donating dye precursor for use in the thermal recording layer is typified by those dye precursors which are used in generally pressure-sensitive recording papers and thermal recording papers, there is no special limitation to be imposed thereon. Specific examples thereof include

(1) triarylmethane compounds: 3,3-bis(p-dimethylaminophenyl)-6-dimethylaminophthalide (Crystal Violet Lactone), 3,3-bis(p-dimethylaminophenyl) phthalide, 3-(p-dimethylaminophenyl)-3-(1,2-dimethylindol-3-yl) phthalide, 3-(p-dimethylaminophenyl)-3-(2-methylindol-3-yl) phthalide, 3-(p-dimethylaminophenyl)-3-(2-phenylindol-3-yl) phthalide, 3,3-bis(1,2-dimethylindol-3-yl) -5-dimethylaminophthalide, 3,3-bis(1,2-dimethylindol-3-yl)-6-dimethylaminophthalide, 3,3-bis(9-ethylcarbazol-3-yl)-5-dimethylaminophthalide, 3,3-bis(2-phenylindol-3-yl)-5-dimethylaminophthalide, 3-p-dimethylaminophenyl-3-(1-methylpyrol-2-yl)-6-dimethylaminophthalide, etc.,

(2) diphenylmethane compounds; 4,4′-bis(dimethylaminophenyl)benzhydrylbenzyl ether, N-chlorophenylleucoauramine, N-2,4,5-trichlorophenylleucoauramine, etc.

(3) xanthene compounds: rhodamine B anilinolactam, rhodamine B-p-chloroanilinolactam, 3-diethylamino-7-benzylaminofluorane, 3-diethylamino-7-octylaminofluorane, 3-diethylamino-7-phenylfluorane, 3-diethylamino-7-chlorofluorane, 3-diethylamino-6-chloro-7-methylfluorane, 3-diethylamino-7-(3,4-dichloroanilino)fluorane, 3-dibutylamino-7-(2-chloroanilino)fluorane, 3-diethylamino-7-(2-chloroanilino)fluorine, 3-diethylamino-6-methyl-7-anilinofluorane, 3-dibutylamino-6-methyl-7-anilinofluorane, 3-dipentylamino-6-methyl-7-anilinofluorane, 3-(N-ethyl -N-tolyl)amino-6-methyl-7-anilinofluorane, 3-piperidino-6-methyl-7-anilinofluorane, 3-(N-ethyl-N-tolyl)amino-6-methyl-7-phenethylfluorane, 3-diethylamino-7-(4-nitroanilino)fluorine, 3-dibutylamino-6-methyl-7-anilinofluorane, 3-(N-methyl-N-propyl)amino-6-methyl-7-anilinofluorane, 3-(N-ethyl-N-isoamyl)amino-6-methyl-7-anilinofluorane, 3-(N-methyl-N-cyclohexyl)amino-6-methyl-7-anilinofluorane, 3-(N-ethyl-N-tetrahydrofurfuryl)amino-6-methyl-7-anilinofluorane, 3-diethylamino-6-methyl-7-(3-trifluoromethylanilino)fluorane, etc.,

(4) thiazine compounds: benzoylleucomethylene blue, p-nitrobenzoylleucomethylene blue, etc., and

(5)spiro compounds; 3-methylspirodinaphthopyran, 3-ethylspirodinaphthopyran, 3,3′-dichlorospirodinaphthopyran, 3-benzylspirodinaphthopyran, 3-methylnaphtho-(3-methoxybenzo)spiropyran, 3-propylspirobenzopyran, etc. These dye precursors may be used singly or in combination.

The electron-accepting compound for use in the thermal recording layer is generally typified by acidic substances, and it is selected particularly from phenol derivatives, aromatic carboxylic acid derivatives, N,N′ -diarylthiourea derivatives, polyvalent metal salts such as zinc salt of an organic compound, or the like.

Specifically, the electron-accepting compound includes known substances; diphenylsulfone derivatives such as 4-hydroxy-4′-isopropoxydiphenylsulfone, 4-hydroxy-4′-n-propoxydiphenylsulfone, 4,4′-dihydroxydiphenylsulfone, 2,4′-dihydroxydiphenylsulfone, 4-hydroxydiphenylsulfone,- 4-hydroxy-4′-methyldiphenylsulfone, 4-hydroxy-4′-methoxydiphenylsulfone, 4-hydroxy-4′-ethoxyphenylsulfone, 4-hydroxy-4′-n-butoxydiphenylsulfone, 4-hydroxy-4′-benzyloxydiphenylsulfone, bis(3-allyl-4-hydroxyphenyl)sulfone, bis(3,5-dibromo-4-hdyroxyphenyl)sulfone, bis(3,5-dichloro-4-hydroxyhenyl)sulfone, 3,4-dihydroxydiphenylsulfone, 3,4-dihydroxy-4′-methyldiphenylsulfone, 3,4,4,′-trihydroxydiphenylsulfone, 3,4,3′, 4′-tetrahydroxydiphenylsulfone, 2,3,4-trihydroxydiphenylsulfone, 3-phenylsulfonyl-4-hydroxydiphenylsulfone, 2,4-bis(phenylsulfonyl)phenol, etc., 4-tert-butylphenol, 2,2′-dihydroxydiphenyl, 2,2′-methylenebis(4-methyl-6-tert-butylphenol), 4,4′-ethylenebis(2-methylphenol), 4,4′-cyclohexylidenebis(2-isopropylphenol), p-phenylphenol, p-hydroxyacetophenone, 1,1-bis(p-hydroxyphenyl)propane, 1,1-bis(p-hydroxyphenyl)pentane, 1,1-bis(p-hydroxyphenyl)hexane, 1,1-bis(p-hydroxyphenyl)cyclohexane, 2,2-bis(p-hydroxyphenyl)propane, 2,2-bis(p-hydroxyphenyl)hexane, 1,1-bis(p-hydroxyphenyl)-2-ethylhexane, 2,2-bis(3-chloro-4-hydroxyphenyl)propane, 1,1-bis(p-hydroxyphenyl)-1-phenylethane, 1,3-di-[2-(p-hydroxyphenyl)-2-propyl]benzene, 1,3-di[2-(3,4-dihydroxyphenyl)-2-propyl]benzene, 1,4-di-[2-(p-hydroxyphenyl)-2-propyl]benzene, 4,4′-hydroxydiphenyl ether, 3,3′-dichloro-4,4′-hydroxyphenyl sulfide, bis(4-hydroxyphenyl) acetic esters such as methyl 2,2-bis(4-hydroxyphenyl)acetate, butyl 2,2-bis(4-hydroxyphenyl)acetate, etc., 4,4′thiobis(2-tert-butyl-5-methylphenol), dimethyl 4-hydroxyphthalate, benzoic acid, hydroxybenzoic esters such as ethyl p-hydroxybenzoate, propyl p-hydroxybenzoate, butyl p-hydroxybenzoate, benzyl p-hydroxybenzoate, etc., benzyl gallate, stearyl gallate, N,N′diphenylthiourea, 4,4′bis(3-(4-methylphenylsulfonyl)ureiodo)diphenylmethane, N-(4-methyl-phenylsulfonyl)-N′phenylurea, salicylanilide, 5-chlorosalicylanilide, salicylic acid, 3-isopropyl salicylic acid, 3-cyclohexyl salicylic acid, 3,5-di-tert-butyl salicylic acid, 3,5-di-α(-methylbenzyl salicylic acid, 4-[2′(4-methoxyphenoxy)ethyloxy]salicylic acid, 3-(octyloxycarbonylamino)salicylic acid, metal salts of these salicylic acid derivatives, gallic acid alkyl esters, phenolic compounds such as a novolak type phenolic resin, etc., naphthoic acid derivatives such as 1-hydroxy-2-naphthoic acid, 2-hydroxy-6-naphthoic acid, etc., and metal salts of these, organic acids such as tartaric acid, oxalic acid, boric acid, citric acid, stearic acid, etc., N-(p-toluenesulfonyl) -N′(3-p-toluenesulfonyloxyphenyl)urea, N-(4-hydroxyphenyl)-p-toluenesulfonamide, N-(4-hydroxyphenyl)benzenesulfonamide, N-(4-hydroxyphenyl)-1-naphthalenesulfonamide, N-(4-hydroxyphenyl)-2-naphthalenesulfonamide, N-(4-hydroxynaphthyl)-p-toluenesulfonamide, N-(4-hydroxynaphthyl)benzenesulfonamide, N-(4-hydroxynaphthyl)-1-naphthalenesulfonamide, N-(4-hydroxynaphthyl)-2-naphthalenesulfonamide, N-(3-hydroxyphenyl)-p-toluenesulfonamide, N-(3-hydroxyphenyl)benzenesulfonamide, N-(3-hydroxyphenyl)-1-naphthalenesulfonamide, N-(3-hydroxyphenyl)-2-naphthalenesulfonamide, and the like. These may be used singly or in combination as required.

The aromatic isocyanate compound for use in the thermal recording layer is a colorless or light-colored compound that is a solid at room temperature. Specifically, the aromatic isocyanate compound includes 2,6-dichlorophenyl isocyanate, p-chlorophenyl isocyanate, 1,3-phenylene diisocyanate, 1,4-phenylene diisocyanate, 1,3-dimethylbenzene-4,6-diisocyanate, 1,4-dimethylbenzene-2,5-diisocyanate, 1-ethoxybenzene-2,4-diisocyanate, 2,5-dimethoxybenzene-1,4-diisocyanate, 2,5-diethoxybenzene-1,4-diisocyanate, 2,5-dibutoxybenzene-1,4-diisocyanate, azobenzene-4,4′diisocyanate, diphenyl ether-4,4′-diisocyanate, naphthalene-1,4-diisocyanate, naphthalene-1,5-diisocyanate, naphthalene-2,6-diisocyanate, naphthalene-2,7-diisocyanate, 3,3′dimethylbiphenyl-4,4′-diisocyanate, 3,3′dimethoxy-4,4′diisocyanate, diphenylmethane-4,4′diisocyanate, diphenyldimethylmethane-4,4′diisocyanate, benzophenone-3,3′-diisocyanate, fluorine-2,7-diisocyanate, anthraquinone-2,6-diisocyanate, 9-ethylcarbazole-3,6-diisocyanate, pyrene-3,8-diisocyanate, naphthalene-1,3,7-triisocyanate, biphenyl-2,4,4′-triisocyanate, 4,4′,4″-triisocyanate-2,5-dimethoxytriphenylamine, p-dimethylaminophenyl isocyanate, tri(4-phenyl isocyanate)thiophosphate, and the like. These may be used singly or in combination as required.

These aromatic isocyanate compounds may be used in the form of so-called block isocyanates that are addition compounds thereof with phenols, lactams, oximes, etc, and may be used in the form of dimers such as a dimer of 1-methylbenzene-2,4-diisocyanate or trimers such as isocyanurate, or they may be also used as polyisocyanates formed by adding them with various polyols.

The imino compound for use in the thermal recording layer is a colorless or light-colored compound that is a solid at a room temperature. Specifically, the imino compound includes 3-imino-4,5,6,7-tetrachloroisoindoline-1-one, 1,3-diimino-4,5,6,7-tetrachloroisoindoline, 1,3-diiminoisoindoline, 1,3-diiminobenz(f)isoindoline, 1,3-diiminonaphtho(2,3-f)isoindoline, 1,3-dimino-5-nitroisoindoline, 1,3-diimino-5-phenylisoindoline, 1,3-diimino-5-methoxyisoindoline, 1,3-diimino-5-chloroisoindoline, 5-cyano-1,3-diiminoisoindoline, 5-acetamido-1,3-diiminoisoindoline, 1,3-diimino-5-(1H-1,2,3-triazol-1-yl)-isoindoline, 5-(p-tert-butylphenoxy)-1,3-diiminoisoindoline, 5- (p-cumylphenoxy)-1,3-diiminoisoindoline, 5-isobutoxy-1,3-diiminoisoindoline, 1,3-diimino-4,7-dimethoxyisoindoline, 4,7-diethoxy-1,3-diiminoisoindoline, 4,5,6,7-tetrabromo-1,3-diiminoisoindoline, 4,5,7-trichloro-1,3-diimino-6-methylmercaptoisoindoline, 1-iminodiphenic acid imide, 1-(cyano-p-nitrophenylmethylene)-3-iminoisoindoline, 1-(cyanobenzothiazolyl-(2′)-carbamoylmethylene)-3-iminoisoindoline, 1-[(cyanobenzimidazolyl-2′)methylene]-3-iminoisoindoline, 1-[(cyanobenzimidazolyl-2′)-methylene]-3-imino-4,5,6,7-tetrachloroisoindoline, 1-[cyanobenzimidazolyl]-2′)-methylene]-3-imino-5-methoxyisoindoline, 1-[(l′phenyl-3′methyl-5-oxo) -pyrazolidene-4′]-3-iminoisoindoline, 3-imino-l-sulfobenzoic acid imide, 3-imino-l-sulfo-4,5,6,7-tetrachlorobenzoic acid imide, 3-imino-1-sulfo-4,5,7-trichloro-6-methylmercaptobenzoic acid imide, 3-imino-2-methyl-4,5,6,7-tetrachloroisoindolin-1-one, and the like. These may be used singly or in combination as required.

In the thermal recording material of the present invention, the thermal recording layer may contain a heat-melting substance for improving its thermal response. The heat-melting substance preferably has a melting point of 60° C. to 180° C., particularly preferably has a melting point of 80° C. to 140° C. Specifically, the heat-melting substance includes known heat-melting substances; stearic acid amide, N-hydroxymethylstearic acid amide, N-hydroxymethylstearic acid amide, N-stearylstearic acid amide, ethylenebisstearic acid amide, N-stearylurea, β-naphthylbenzyl ether, m-terphenyl, 4-benzylbiphenyl, 2,2′bis(4-methoxyphenoxy)diethyl ether, α, α′-diphenoxyxylyene, bis(4-methoxyphenyl)ether, 1,2-di(3-methylphenoxy)ethane, 1,2-diphenoxyethane, diphenyl adipate, oxalic diester derivatives such as dibenzyl oxalate, di(4-chlorobenzyl) oxalate, di(4-methylbenzyl) oxalate, etc., sulfone compounds such as diphenyl sulfone, dimethyl terephthalate, dibenzyl terephthalate, phenyl benzenesulfonate, bis(4-allyloxyphenyl) sulfone, 4-acetylacetophenone, acetoacetic acid anilides, fatty acid anilides, and the like. These compounds may be used singly or in combination as required. Further, preferably, the content of the heat-melting substance in the total solid content of the thermal recording layer is 5 to 50 mass % for obtaining sufficient thermal response.

The binder for use in the thermal recording layer can be selected from various binders that are used for general coating. Specifically, the binder includes water-soluble binders such as starches, hydroxymethyl cellulose, methyl cellulose, ethyl cellulose, carboxymethyl cellulose, gelatin, casein, polyvinyl alcohol, modified polyvinyl alcohol, sodium alginate, polyvinyl pyrolidone, polyacrylamide, an acrylamide/acrylate copolymer, an acrylamide/acrylate/methacrylic acid terpolymer, an alkali salt of polyacrylic acid, an alkali salt of polymaleic acid, an alkali salt of a styrene/maleic anhydride copolymer, an alkali salt of an ethylene/maleic anhydride copolymer, an alkali salt of an isobutylene/maleic anhydride copolymer, etc., and water-dispersible binders such as a styrene/butadiene copolymer, an acrylonitrile/butadiene copolymer, a methyl acrylate/butadiene copolymer, an acrylonitrile/butadiene/styrene terpolymer, polyvinyl acetate, a vinyl acetate/acrylate copolymer, an ethylene/vinyl acetate copolymer, polyacrylic ester, a styrene/acrylate copolymer, polyurethane, etc., while the binder shall not be limited to these. These may be used singly or in combination as required.

In addition to these, the thermal recording layer may contain, as a pigment, inorganic pigments such as diatomite, talc, kaolin, calcined kaolin, calcium bicarbonate, precipitable calcium carbonate, chalk, magnesium carbonate, zinc oxide, aluminum oxide, aluminum hydroxide, magnesium hydroxide, titanium dioxide, barium sulfate, zinc sulfate, amorphous silica, amorphous calcium silicate, colloidal silica, etc., or and organic pigments such as a melamine resin filler, a urea-formalin resin filler, a polyethylene powder, a nylon powder, and the like.

The thermal recording layer optionally contains higher fatty acid metal salts such as zinc stearate, calcium stearate, etc., lubricants such as paraffin, polyethylene wax, polyethylene oxide, castor wax, etc., ultraviolet absorbents such as a benzophenone-containing ultraviolet absorbent, a benzotriazole-containing ultraviolet absorbent, etc., and an anionic or nonionic surfactant (including a high-molecular-weight surfactant), and may further optionally contains a fluorescent dye, an anti-foaming agent, and the like as required.

In the present invention, thermal recording layer is obtained by mixing aqueous dispersions in which colorable components are dispersed in a finely milled state, with a binder, etc., applying the mixture onto a substrate and drying the applied mixture. The thermal recording layer may have a single-layer or multi-layered constitution.

The application amount for the thermal recording layer is suitably such that the application amount of a dye precursor solid content is generally in the range of 0.1 to 2.0 g/m2. When it is in the above range, economically advantageously, a sufficient recording density can be obtained.

In the present invention, paper is mainly used as a substrate. In addition to paper, the substrate can be selected from various woven fabrics, non-woven fabrics, synthetic resin films, synthetic resin laminated papers, metal foils, deposition sheets, or composite sheets obtained by combining these by laminating, as required.

The thermal recording material of the present invention may be provided, as required, with an intermediate layer formed of a single layer or a plurality of layers between the thermal recording layer and the protective layer and at least one undercoat layer formed of a single layer or a plurality of layers formed from a pigment or a resin between the substrate and the thermal recording layer.

The intermediate layer includes, for example, a layer formed from a resin and a crosslinking agent as described in JP-A-59-45191 and a layer containing an ultraviolet absorbent as described in JP-A-7-179045 or JP-A-2000-185472.

When the thermal recording material of the present invention has an undercoat layer, the application amount of a solid content for the undercoat layer is preferably 1 to 30 g/m, more preferably 3 to 20 g/m2.

Calcined kaolin is generally used as a pigment for the undercoat layer. Besides it, the pigment can be selected from inorganic pigments such as diatomite, talc, kaolin, calcium bicarbonate, precipitable calcium carbonate, chalk, magnesium carbonate, zinc oxide, aluminum oxide, aluminum hydroxide, magnesium hydroxide, titanium dioxide, barium sulfate, zinc sulfate, amorphous silica, amorphous calcium silicate, colloidal silica, etc., or and organic pigments such as a melamine resin filler, a urea-formalin resin filler, a polyethylene powder, a nylon powder, and the like. Further, organic spherical particles, organic hollow particles, etc., can be also used.

The binder for the undercoat layer can be selected from various water-soluble resins or water-dispersible resins that are used in general coating. For example, the binder includes water-soluble resins such as starches, hydroxymethyl cellulose, methyl cellulose, ethyl cellulose, carboxymethyl cellulose, gelatin, casein, polyvinyl alcohol, modified polyvinyl alcohol, sodium alginate, polyvinyl pyrolidone, polyacrylamide, an acrylamide/acrylate copolymer, an acrylamide/acrylate/methacrylic acid terpolymer, an alkali salt of polyacrylic acid, an alkali salt of polymaleic acid, an alkali salt of a styrene/maleic anhydride copolymer, an alkali salt of an ethylene/maleic anhydride copolymer and an alkali salt of an isobutylene/maleic anhydride copolymer, etc., and water-dispersible binders such as a styrene/butadiene copolymer, an acrylonitrile/butadiene copolymer, a methyl acrylate/butadiene copolymer, an acrylonitrile/butadiene/styrene terpolymer, polyvinyl acetate, a vinyl acetate/acrylate copolymer, an ethylene/vinyl acetate copolymer, a polyacrylic ester copolymer, a styrene/acrylate copolymer, polyurethane, and the like.

The thermal recording material of the present invention can be obtained by consecutively forming the thermal recording layer and protective layer on the substrate. The thermal recording layer may be formed after formation of the undercoat layer on the substrate as required, and the intermediate layer may be formed after formation of the thermal recording layer.

The method for forming each of the thermal recording layer, the protective layer, the intermediate layer and the undercoat layer is not specially limited, and they can be formed according to known methods. As a specific embodiment, there can be employed a constitution in which each coating liquid is applied by the method of air knife coating, rod blade coating, bar coating, blade coating, gravure coating, curtain coating, E bar coating or the like and then each applied coating liquid is dried, to form the thermal recording layer, the protective layer, the intermediate layer and the undercoat layer. Further, super calendering may be carried out after formation of the undercoat layer, after formation of the thermal recording layer, after formation of the intermediate layer or after formation of the protective layer, for improving the thermal recording material in image quality.

The present invention will be explained with reference to Examples hereinafter, while the present invention shall not be limited by these Examples. In Examples, “%” and “part” are both based on weight.

(Preparation of Dispersions)

Dispersions A, B, C, D, E and F were prepared according to the following methods.

(Dispersion A)

200 Grams of 3-dibutylamino-6-methyl-7-anilinofluorane was dispersed in a mixture of 200 g of a 10% polyvinyl alcohol aqueous solution with 600 g of water and milled with a bead mill until it had an average particle diameter of 1 μm.

(Dispersion B)

400 Grams of 2,2-bis(p-hydroxyphenyl)propane was dispersed in a mixture of 400 g of a 10% polyvinyl alcohol aqueous solution with 200 g of water and milled with a bead mill until it had an average particle diameter of 1 μm.

(Dispersion C) 400 Grams of β-naphthyl benzyl ether was dispersed in a mixture of 400 g of a 10% polyvinyl alcohol aqueous solution with 200 g of water and milled with a bead mill until it had an average particle diameter of 1 μm.

(Dispersion D)

200 Grams of preciptable calcium carbonate was dispersed in 800 g of a 0.5% sodium polyacrylate aqueous solution and dispersed with a homomixer for 10 minutes.

(Dispersion E)

200 Grams of amorphous silica ((Mizukasil P527, supplied by Mizusawa Industrial Chemicals, Ltd.) was dispersed in 800 g of a 0.5% sodium polyacrylate aqueous solution and dispersed with a homomixer for 10 minutes.

(10% Chitosan Aqueous Solution)

400 Grams of water was added to 50 g of chitosan (OTS-2, supplied by Kuraray Co., Ltd.), 50 g of 50% lactic acid was added with stirring, and the mixture was further stirred to prepare a 10% chitosan aqueous solution.

(50% Block Isocyanate Aqueous Solution)

6.8 Parts of hexamethylene diisocyanate and 8.2 parts of sodium metabisulfite were dissolved in 15 parts of water, and the mixture was sealed and stirred for 20 hours to prepare a block isocyanate aqueous solution.

### EXAMPLE 1

<Thermal Recording Layer>

Materials including Dispersions A to D were mixed in the following amount ratio, and the mixture was fully stirred to prepare a thermal recording layer coating liquid.

| | |
|---|---|
| Dispersion A | 20 parts |
| Dispersion B | 15 parts |
| Dispersion C | 15 parts |
| Dispersion D | 25 parts |
| 10% Polyvinyl alcohol aqueous solution | 30 parts |
| Water | 30 parts |

The thus-prepared thermal recording layer coating liquid was applied to a base paper having a basis weight of 40 g/m2 such that the solid content coating amount of a dye precursor was 0.3 g/m2, and the applied coating liquid was dried and then super calendered to obtain a material having a thermal recording layer.

<Protective Layer>

Materials were mixed in the following amount ratio, and the mixture was fully stirred to prepare a protective layer coating liquid.

| | |
|---|---|
| 10% Completely saponified polyvinyl alcohol aqueous | 80 parts |
| solution (PVA-1177, supplied by Kuraray Co., Ltd.) | |
| 10% Chitosan aqueous solution | 20 parts |
| 25% Glyoxal aqueous solution | 3.2 parts |
| 20% Cationic colloidal silica aqueous dispersion | 15 parts |
| (SNOWTEX AK, supplied by Nissan Chemical | |
| Industries, Ltd., average particle diameter 10 to 20 nm) | |
| 40% Zinc stearate aqueous solution | 2 parts |
| Water | 80 parts |

A protective layer coating liquid prepared in the above amount ratio was applied to the above-obtained thermal recording layer so as to have a solid content coating amount of 2 g/m², and the applied coating liquid was super calendered to give a thermal recording material.

### EXAMPLE 2

A thermal recording material was obtained in the same manner as in Example 1 except that the 25% glyoxal aqueous solution in the formulation of the protective layer in Example 1 was replaced with a 25% polyamide epichlorohydrin resin (WS-547, supplied by Seiko PMC Corporation) aqueous solution having the same amount as that of the 25% glyoxasole aqueous solution.

### EXAMPLE 3

A thermal recording material was obtained in the same manner as in Example 1 except that 3.2 parts of the 25% glyoxal aqueous solution in the formulation of the protective layer in Example 1 was replaced with 1.6 parts of a 50% block isocyanate aqueous solution and 1.6 parts of water.

### EXAMPLE 4

A thermal recording material was obtained in the same manner as in Example 1 except that 3.2 parts of the 25% glyoxal aqueous solution in the formulation of the protective layer in Example 1 was replaced with 1.6 parts of a 25% glyoxal aqueous solution and 1.6 parts of a 25% polyamide epichlorohydrin resin (WS-547, supplied by Seiko PMC Corporation) aqueous solution.

### EXAMPLE 5

A thermal recording material was obtained in the same manner as in Example 1 except that 3.2 parts of the 25% glyoxal aqueous solution in the formulation of the protective layer in Example 1 was replaced with 1.6 parts of a 25% glyoxal aqueous solution, 0.8 part of a 50% block isocyanate aqueous solution and 0.8 part of water.

### EXAMPLE 6

A thermal recording material was obtained in the same manner as in Example 1 except that 3.2 parts of the 25% glyoxal aqueous solution in the formulation of the protective layer in Example 1 was replaced with 1.6 parts of a 25% polyamide epichlorohydrin resin (WS-547, supplied by Seiko PMC Corporation) aqueous solution, 0.8 part of a 50% block isocyanate aqueous solution and 0.8 part of water.

### EXAMPLE 7

A thermal recording material was obtained in the same manner as in Example 1 except that 3.2 parts of the 25% glyoxal aqueous solution in the formulation of the protective layer in Example 1 was replaced with 16 parts of a 5% boric acid aqueous solution and that the amount of water was changed from 80 parts to 67.2 parts.

### EXAMPLE 8

A thermal recording material was obtained in the same manner as in Example 1 except that the amount of the 10% completely saponified polyvinyl alcohol aqueous solution in the formulation of the protective layer in Example 1 was changed from 80 parts to 60 parts and that the amount of the 10% chitosan aqueous solution in the formulation of the protective layer was changed from 20 parts to 40 parts.

### EXAMPLE 9

A thermal recording material was obtained in the same manner as in Example 1 except that the amount of the 10% completely saponified polyvinyl alcohol aqueous solution in the formulation of the protective layer in Example 1 was changed from 80 parts to 95 parts and that the amount of the 10% chitosan aqueous solution in the formulation of the protective layer was changed from 20 parts to 5 parts.

### EXAMPLE 10

A thermal recording material was obtained in the same manner as in Example 1 except that the 20% cationic colloidal silica aqueous dispersion in the formulation of the protective layer in Example 1 was replaced with a 20% anionic colloidal silica aqueous dispersion (SNOWTEX C, supplied by Nissan Chemical Industries, Ltd., average particle diameter 10 to 20 nm)

### EXAMPLE 11

A thermal recording material was obtained in the same manner as in Example 1 except that 80 parts of the 10% completely saponified polyvinyl alcohol aqueous solution in the formulation of the protective layer in Example 1 was replaced with 80 parts of a 10% partially saponified polyvinyl alcohol aqueous solution (PVA-217, supplied by Kuraray Co., Ltd., saponification degree 88%).

Thermal Recording Material

### EXAMPLE 12

A thermal recording material was obtained in the same manner as in Example 1 except that 80 parts of the 10% completely saponified polyvinyl alcohol aqueous solution in the formulation of the protective layer in Example 1 was replaced with 80 parts of a 10% silanol-modified polyvinyl alcohol aqueous solution (R-1130, supplied by Kuraray Co., Ltd.).

### EXAMPLE 13

A thermal recording material was obtained in the same manner as in Example 1 except that 80 parts of the 10% completely saponified polyvinyl alcohol aqueous solution in the formulation of the protective layer in Example 1 was replaced with 80 parts of a 10% epoxy-modified polyvinyl alcohol aqueous solution (W100, supplied by Denki Kagaku Kogyo K.K.).

### EXAMPLE 14

A thermal recording material was obtained in the same manner as in Example 1 except that 80 parts of the 10% completely saponified polyvinyl alcohol aqueous solution in the formulation of the protective layer in Example 1 was replaced with 80 parts of a 10% diacetone-modified polyvinyl alcohol aqueous solution (D1700, supplied by The Shin-Etsu Chemical Co., Ltd.).

### EXAMPLE 15

A thermal recording material was obtained in the same manner as in Example 1 except that 80 parts of the 10% completely saponified polyvinyl alcohol aqueous solution in the formulation of the protective layer in Example 1 was replaced with 80 parts of a 10% acetoacetyl-modified polyvinyl alcohol aqueous solution (Z200, supplied by Nippon Synthetic Chemical Industry Co., Ltd.).

### EXAMPLE 16

A thermal recording material was obtained in the same manner as in Example 13 except that the amount of the 25% glyoxal aqueous solution in the formulation of the protective layer in Example 13 was changed from 3.2 parts to 6 parts and that 1.6 parts of a 25% polyamide epichlorohydrin resin (WS-547, supplied by Seiko PMC Corporation) aqueous solution was added in the formulation of the protective layer.

### EXAMPLE 17

A thermal recording material was obtained in the same manner as in Example 1 except that 15 parts of the 20% cationic colloidal silica aqueous dispersion in the formation of the protective layer in Example 1 was replaced with 10 parts of a 30% large-particle-diameter cationic colloidal silica aqueous dispersion. (SNOWTEX AK-YL, supplied by Nissan Chemical Industries, Ltd., average particle diameter 70 to 80 nm) and 5 parts of water.

### EXAMPLE 18

A thermal recording material was obtained in the same manner as in Example 1 except that 80 parts of the 10% completely saponified polyvinyl alcohol aqueous solution and 20 parts of the 10% chitosan aqueous solution in the formulation of the protective layer in Example 1 were replaced with 64 parts of a 10% completely saponified polyvinyl alcohol aqueous solution, 16 parts of a 10% chitosan aqueous solution and 6.7 parts of a 30% nonionic acryl emulsion (Biniplan 2685, supplied by The Shin-Etsu Chemical Co., Ltd.).

### EXAMPLE 19

A thermal recording material was obtained in the same manner as in Example 18 except that 64 parts of the 10% completely saponified polyvinyl alcohol aqueous solution in the formulation of the protective layer in Example 18 was replaced with 64 parts of a 10% epoxy-modified polyvinyl alcohol aqueous solution (W100, supplied by Denki Kagaku Kogyo K.K.) and that 3.2 parts of the 25% glyoxal aqueous solution in the formulation of the protective layer in Example 18 was replaced with 1.6 parts of a 25% glyoxal aqueous solution, 0.8 part of a 50% block isocynate aqueous solution and 0.8 part of water.

### EXAMPLE 20

A thermal recording material was obtained in the same manner as in Example 19 except that 15 parts of the 20% cationic colloidal silica aqueous dispersion in the formation of the protective layer in Example 19 was replaced with 10 parts of a 30% large-particle-diameter cationic colloidal silica aqueous dispersion (SNOWTEX AK-YL, supplied by Nissan Chemical Industries, Ltd., average particle diameter 70 to 80 nm) and 5 parts of water.

### COMPARATIVE EXAMPLE 1

A thermal recording material was obtained in the same manner as in Example 1 except that 15 parts of the 20% cationic colloidal silica aqueous dispersion in the formation of the protective layer in Example 1 was replaced with 15 parts of Dispersion E.

### COMPARATIVE EXAMPLE 2

A thermal recording material was obtained in the same manner as in Example 1 except that 15 parts of the 20% cationic colloidal silica aqueous dispersion in the formation of the protective layer in Example 1 was replaced with 15 parts of water.

### COMPARATIVE EXAMPLE 3

A thermal recording material was obtained in the same manner as in Example 1 except that 20 parts of the 10% chitosan aqueous solution in the formulation of the protective layer in Example 1 was replaced with 20 parts of a 10% completely saponified polyvinyl alcohol.

### COMPARATIVE EXAMPLE 4

A thermal recording material was obtained in the same manner as in Example 1 in the formation of the protective layer in Example 1 except that 3.2 parts of the 25% glyoxal aqueous solution was replaced with 3.2 parts of water.

### COMPARATIVE EXAMPLE 5

A thermal recording material was obtained in the same manner as in Example 1 except that 20 parts of the 10% chitosan aqueous solution in the formation of the protective layer in Example 1 was replaced with 10 parts of a 20% anionic acryl emulsion (OM1050, supplied by Mitsui Chemicals, Inc.) and 10 parts of water.

### COMPARATIVE EXAMPLE 6

A thermal recording material was obtained in the same manner as in Example 1 except that no protective layer was formed.

The protective layer coating liquids prepared in the above examples 1 to 20 and Comparative Examples 1 to 6 were evaluated for liquid properties, and the thermal recording materials obtained were tested as follows. Table 1 shows the results.

(1) Coating Liquid Property

Prepared protective layer coating liquids were evaluated for liquid properties with the passage of time. The valuation was made according to the following ratings.

⊚: A coating liquid was free of gelling and coagulation and permitted coating without any problem.

∘: While a coating liquid permitted coating, it showed an increase in viscosity to some extent or showed coagulation to some extent.

Δ: While a coating liquid permitted coating, it showed an increase in viscosity or coagulation.

X: A coating liquid greatly increased in viscosity or coagulated, so that no coating was permitted.

(2) Printing Sensitivity

Printing was carried out on the obtained thermal recording materials with a facsimile tester TH-PMD supplied by Ohkura Electric Co., Ltd. A thermal head having a dot density of 8 dots/mm and a head resistance of 1681 Ω was used, and the tester was electrically powered at a head voltage of 23 V at a pulse width of 1.0 msec. Each image was measured for a color density with a Macbeth RD-918 reflection densitometer. In the five-stage evaluation, a larger value shows that a thermal recording material has higher printing sensitivity, and it was judged that thermal recording materials rated at 3 or more were at a practical use level.

(3) Plasticizer Resistance

A color-formed surface of each of. thermal recording materials on which printing was carried out under the conditions in (2) was intimately contacted to a commercially available soft vinyl chloride film, and they were left in a 40° C. and 90% high-temperature chamber for 2 days. Then, a printed portion on each thermal recording material was measured for a color density, followed by comparisons. The thermal recording materials were evaluated according to the following ratings.

⊚: There is almost no change in density of a printed portion after the testing.

∘: The density in a printed portion decreases to some extent after the testing.

Δ: The density in a printed portion decreases to a great extent after the testing.

X: Almost no printed portion remains after the testing.

(4) Water Resistance

Five milliliters of water was dropped on the thermal recording materials on which printing was carried out under conditions in (2), followed by rubbing with a finger for 10 seconds. The thermal recording materials were evaluated according to the following ratings.

⊚: There is almost no change in a protective layer, and there is no change in a printed portion, either.

∘: While a protective layer peels off to some extent, there is almost no change in a printed portion.

Δ: While a protective layer peels off, there is almost no change in a printed portion.

X: A protective layer completely peels off, and a printed portion also peels off.

(5) Writability with Pencil

Characters were written on each of the obtained thermal recording materials, and the thermal recording materials were evaluated for writability with a pencil. The thermal recording materials were evaluated according to the following ratings.

⊚: Characters are writable without any problem, and the characters are clear.

∘: While characters were writable, the characters are less clear to some extent.

Δ: Characters are light in density.

X: Written characters are hard to recognize.

(6) Stampability

Printing was carried out on thermal recording materials with a dye-based ink X stamper supplied by Shachihata Inc., and after 10 seconds, a dry cloth was wiped over a stamped portion, followed by-evaluation for remaining properties of stamped characters. The thermal recording materials were evaluated according to the following ratings.

⊚: Stamped characters mostly remain.

∘: While stamped characters becomes light in density to some extent, they are clearly recognizable.

Δ: While satamped characters becomes light in density to some extent, they are somehow recognizable.

X: Stamped characters are not recognizable.

(7) Whiteness

Obtained thermal recording materials were left in an atmosphere at 60° C. for 1 week, and measured for whiteness, followed by comparisons with those obtained before the treatment. The thermal recording materials were evaluated according to the following ratings.

⊚: There is almost no change from the whiteness obtained before the treatment.

602 :There is caused a decrease in whiteness to such an extent that the decrease is not recognizable with the eyes.

Δ: There is caused a decrease in whiteness to such an extent that the decrease is somehow recognizable with the eyes.

TABLE 1

| | Coating | | | | Writability | | |
|---|---|---|---|---|---|---|---|
| | liquid | Thermal | Plasticizer | Water | with | | |
| | property | printing | resistance | resistance | pencil | Stampability | Whiteness |
| Example 1 | ◯ | 4 | ⊚ | ◯ | ◯ | ◯ | ◯ |
| Example 2 | ◯ | 4 | ⊚ | Δ | ◯ | ⊚ | ⊚ |
| Example 3 | ◯ | 4 | ⊚ | Δ | ◯ | ◯ | ⊚ |
| Example 4 | ◯ | 4 | ⊚ | ◯ | ◯ | ⊚ | ⊚ |
| Example 5 | ◯ | 4 | ⊚ | ◯ | ◯ | ◯ | ⊚ |
| Example 6 | ◯ | 4 | ⊚ | Δ | ◯ | ⊚ | ⊚ |
| Example 7 | ◯ | 4 | ⊚ | Δ | ◯ | ◯ | ⊚ |
| Example 8 | Δ | 4 | ⊚ | ⊚ | ◯ | ◯ | Δ |
| Example 9 | ◯ | 4 | ◯ | Δ | Δ | Δ | ⊚ |
| Example 10 | Δ | 4 | ◯ | ◯ | ◯ | ◯ | ◯ |
| Example 11 | ◯ | 4 | ⊚ | Δ | ◯ | ◯ | ◯ |
| Example 12 | ◯ | 4 | ⊚ | ⊚ | ◯ | ◯ | ◯ |
| Example 13 | ◯ | 4 | ⊚ | ⊚ | ◯ | ◯ | ◯ |
| Example 14 | ◯ | 4 | ⊚ | ⊚ | ◯ | ◯ | ◯ |
| Example 15 | Δ | 4 | ⊚ | ⊚ | ◯ | ◯ | ◯ |
| Example 16 | ◯ | 4 | ⊚ | ⊚ | ◯ | ⊚ | ⊚ |
| Example 17 | ◯ | 4 | ⊚ | ◯ | ⊚ | ⊚ | ◯ |
| Example 18 | ◯ | 4 | ⊚ | ⊚ | ◯ | ⊚ | ⊚ |
| Example 19 | ◯ | 4 | ⊚ | ⊚ | ◯ | ⊚ | ⊚ |
| Example 20 | ◯ | 4 | ⊚ | ⊚ | ⊚ | ⊚ | ⊚ |
| CEx. 1 | X | 3 | X | ◯ | ⊚ | ⊚ | ◯ |
| CEx. 2 | ◯ | 4 | Δ | ◯ | X | X | ⊚ |
| CEx. 3 | ◯ | 4 | Δ | X | X | X | ⊚ |
| CEx. 4 | ◯ | 4 | ⊚ | X | ◯ | ◯ | ⊚ |
| CEx. 5 | X | 3 | X | Δ | ◯ | ⊚ | ⊚ |
| CEx. 6 | — | 5 | X | X | Δ | ⊚ | ⊚ |

CEx. = Comparative Example

As is clear from Table 1, when compared with Example 1 using chitosan, it is seen that Comparative Examples 3 and 5 using no chitosan are inferior in water resistance, and particularly that Comparative Example 5 using an anionic acryl emulsion is poor in coating liquid property, water resistance and plasticizer durability. Further, when Example 1 using colloidal silica is compared with Comparative Examples 1 and 2 using no colloidal silica, it is seen that Comparative Example 1 is poor in coating liquid property and plasticizer durability, and that Comparative Example 2 is poor in plasticizer durability, writability with a pencil and stampability.

Further, when Examples 1 to 3 and 7 are compared with Comparative Example 4, it is seen that glyoxal is the most effective as a crosslinking agent for improvments in water resistance, it is seen that a polyamide epichlorohydrin resin or block diisocynate is excellent in improvements in whiteness, and it is also seen that the stampability is improved when a polyamide epichlorohydrin resin is used.

When Example 4 is compared with Comparative Examples 1 to 3, or when Example 13 is compared with Example 16, it is seen that the water resistance and the stampability can be satisfied at the same time by using glyoxal and a polyamide epichlorohydrin resin as crosslinking agents, when Example 5 is compared with Examples 1 to 3, it is seen that the water resistance and the whiteness can be satisfied together by using glyoxal and block isocyanate, and when Example 6 is compared with Examples 1 to 3, it is seen that the whiteness and the stampability can be satisfied together by using a polyamide epichlorohydrin resin and block isocyanate.

Further, when Example 1 is compared with Comparative Example 10, it is seen that a protective layer coating liquid free from gelling and coagulation can be prepared by using cationic colloidal silica as a colloidal silica, and that the thus-obtained thermal recording material is excellent in plasticizer durability.

Further, when Example 1 is compared with Examples 8 and 9, it is seen that the coating liquid property and the water resistance can be satisfied together when the amount ratio of polyvinyl alcohol and chitosan by mass is 8:2 in Example 1, that while the water resistance is improved, the liquid property of a coating liquid is poor due to a little increase in viscosity when it is 6:4 in Example 8, and that the water resistance, the writability with a pencil and the stampability are poor as compared with Example 1 when it is 9.5:0.5 in Example 9.

Further, when Example 1 is compared with Example 11, it is seen that a completely saponified polyvinyl alcohol serves to accomplish excelelnt water resitance over a partially saponified polyvinyl alcohol. When Example 1 is compared with Examples 12 to 15, or when Example 4 is compared with Example 16, it is seen that the use of at least one member selected from silanol-modified polyvinyl alcohol, epoxy-modified polyvinyl alcohol, diacetone-modified polyvinyl alcohol or acetoacetyl-modified polyvinyl alcohol serves to accomplish excellent water resistance over completely saponified polyvinyl alcohol.

Further, when Exmple 1 is compared with Example 18, it is seen that Example 18 in which the protective layer contains a nonionic acryl emulsion is improved in water resistance and stampability over Example 1 in which the protective layer does not contain the same.

Further, when Example 1 is compared with Example 17, or when Example 19 is compared with Example 20, it is seen that the writability with a pencil is more improved with an increase in the average particle diameter of colloidal silica. Further, when Example 1 is compared with Example 17, it is seen that the stampability is more improved with an increase in the average particle diameter of colloidal silica.

### INDUSTRIAL UTILITY

According to the present invention, there can be provided a thermal recording material that is excellent in water resistance and oil resistance and that is satisfactory in writability and stampability.

1. A thermal recording material comprising a thermally colorable thermal recording layer formed on a substrate and a protective layer formed on said thermal recording layer,
said protective layer containing a polyvinyl alcohol, chitosan, a crosslinking agent and a pigment, and said pigment containing colloidal silica.

2. The thermal recording material of claim 1, wherein as said crosslinking agent is used at least one member selected from an aldehyde-containing compound, a polyamide epichlorohydrin resin or an isocyanate compound.

3. The thermal recording material of claim 2, wherein as said crosslinking agent are used at least two members selected from an aldehyde-containing compound, a polyamide epichlorohydrin resin and an isocyanate compound.

4. The thermal recording material of claim 1, wherein said colloidal silica is cationic colloidal silica.

5. The thermal recording material of claim 1, wherein said polyvinyl alcohol and said chitosan have a solid content mass ratio of from 7:3 to 9:1.

6. The thermal recording material of claim 1, wherein said polyvinyl alcohol is at least one member selected from a non-modified polyvinyl alcohol having a saponification degree of at least 95%, a silanol-modified polyvinyl alcohol, an epoxy-modified polyvinyl alcohol, a diacetone-modified polyvinyl alcohol or an acetoacetyl-modified polyvinyl alcohol.

7. The thermal recording material of claim 1, wherein said protective layer contains a water-dispersible binder other than any anionic binder.
